(19) United States
(12) Patent Application Publication
(10) Pub. No.: US 2011/0227289 A1
(43) Pub. Date: Sep. 22, 2011

(54) BRUSH SEAL

(75) Inventor: Beichl Stefan, Herrsching (DE)

(73) Assignee: MTU AERO ENGINES GMBH, Münich (DE)

(21) Appl. No.: 13/132,876

(22) PCT Filed: Dec. 2, 2009
(86) PCT No.: PCT/DE09/01697

§ 371 Date: Jun. 3, 2011

(30) Foreign Application Priority Data
Dec. 3, 2008 (DE) 10 2008 060 371.6

(51) Int. Cl. F16J 15/44

(52) U.S. Cl. 277/355

(57) ABSTRACT

The invention relates to a brush seal to seal a gap between two structural components, in particular between a rotor and a stator, having a bristle packet comprising bristles, with the bristles of the bristle packet being firmly attached to a bristle carrier via a fixation element. According to the invention, the bristle packet comprises several layers of bristles that are made of different materials.

### BACKGROUND

Gas turbines consist of several modules, for example of at least one compressor, at least one combustion chamber as well as at least one turbine. The compressor or each of the compressors as well as the turbine or each of the turbines are equipped with a rotor which rotates relative to a stationary stator. The stator involves in particular a stationary housing to which stationary guide vanes are allocated. Guide vanes are allocated to the rotor that rotate together with the rotor relative to the stationary guide vanes as well as to the stationary housing.

Optimizing the efficiency of the gas turbines will require the minimizing of leakage flows. This applies, on the one hand, to leakage flows between components rotating relative to each other, and, on the other hand, to leakage flows between stationary components. Seal arrangements to seal a gap between components rotating relative to each other are also called dynamic seal arrangements. Seal arrangements to seal a gap between stationary components are also called static seal arrangements.

For the sealing of so-called annular gaps between components rotating relative to each other, to with between a rotor and a stator, brush seals have proved to be of value.

From EP 1 203 178 B1, a seal arrangement has been known in which a brush seal is positioned in a receptacle defined by a housing. The brush seal comprises a bristle packet of several bristles that are attached to a bristle carrier with the aid of fixation element, with the bristles of the bristle packet protruding from the receptacle defined by the housing and lying flat against the rotor. The housing forming the receptacle for the brush seal comprises a support element and a cover element. According to EP 1 203 178 B1, the bristles of the bristle packet of the brush seal are designed as synthetic fibers, for example Aramid fibers or, respectively, Kevlar fibers.

### SUMMARY AND DESCRIPTION

Therefore, an objective of the invention is to provide a novel brush seal. This problem is addressed by a brush seal as disclosed and claimed herein.

According to one aspect of the invention, the bristle packet comprises several layers of bristles made of different materials.

One embodiment of the invention is a brush seal whose bristles comprise bristles made of different materials. Therefore, the bristle packet of the brush seal according to this embodiment of the invention comprises several layers of bristles made of different materials. This makes it possible to create brush seals that, on the one hand, have a good sealing effect and that, on the other hand, are characterized by great mechanical resistance as well as by high temperature resistance.

Preferably, the bristle packet of the brush seal according to another embodiment of the invention comprises an interior layer whose bristles are made of carbon fibers as well as an exterior layer whose bristles are designed as Aramid fibers or as wire fibers made of Haynes 25 wire. Such a brush seal with a bristle packet in a hybrid design distinguishes itself through particular advantageous temperature resistance as well as through mechanical resistance and therefore through longevity as well as through a particularly advantageous sealing effect.

### BRIEF DESCRIPTION OF THE DRAWINGS

Preferred further developments of the invention result from the subclaims and the subsequent description. Embodiments of the invention will be explained with the aid of the drawings without being limited thereto. Shown are:

FIG. 1 shows a brush seal according to the invention per a first embodiment of the invention;

FIG. 2 shows a brush seal according to the invention per a second embodiment of the invention;

FIG. 3 shows a brush seal according to the invention per a third embodiment of the invention; and

FIG. 4 shows a brush seal according to the invention per a fourth embodiment of the invention.

### DETAILED DESCRIPTION

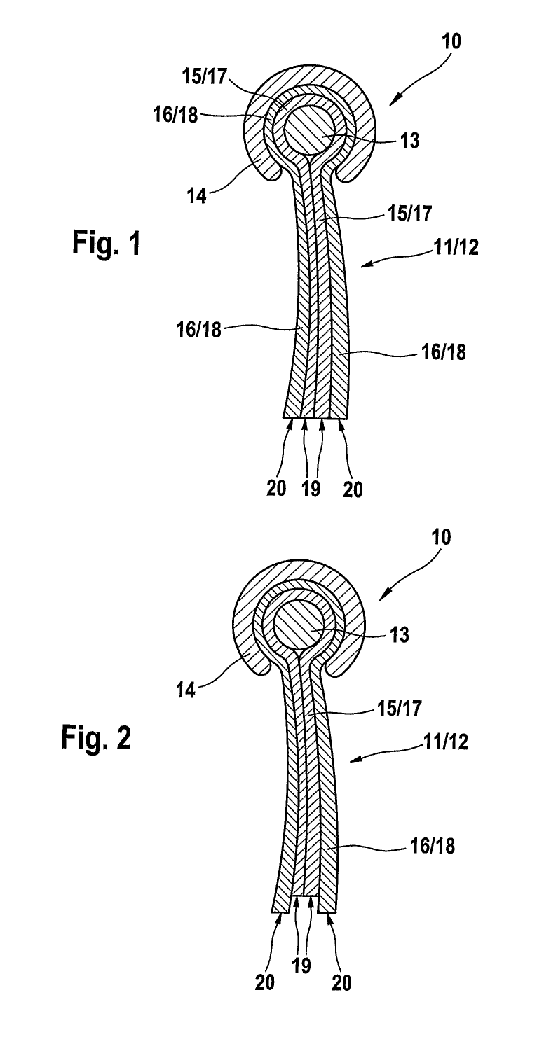

FIG. 1 shows a schematic representation of a brush seal 10 according to the invention per a first embodiment of the invention at hand here, with the brush seal 10 of FIG. 1 comprising a bristle packet 11 of several bristles 12 and with the bristles 12 of the bristle packet 11 being firmly attached to a wire-like bristle carrier 13 by means of a fixation element 14 having a C-shaped cross section.

In the sense of the invention at hand here, the bristle packet 11 of the brush seal 10 according to the invention comprises several layers of bristles, to with, in the embodiment shown, two layers 15 and 16 of bristles 17 and 18 that are wound in overlapping fashion around the bristle carrier 13 and firmly attached to the same so that the bristles 17 of layer 15 form an interior layer and the bristles 18 of layer 16, an exterior layer. The exterior layer may also be designated as a cover layer. In the sense of the invention at hand here, the bristles 17, 18 of the layers 15, 16 differ with regard to their material composition. For example, the bristles 17 of the interior layer 15 of the bristle packet 11 are designed as carbon fibers. The bristles 18 of the exterior layer 16, on the other hand, are designed as Aramid fibers or as wire fibers made of Haynes 25 wire.

As has been known from EP 1 203 178 B1, the brush seal 10 represented in FIG. 1 is preferably positioned in a housing so as to form a sealing arrangement that comprises a cover element and a support element, with the free ends 19, 20 of the bristles 17, 18 protruding from the housing and preferably lying flat against a rotor. Reference be made to EP 1 203 178 B1 with regard thereto. Consequently, in FIG. 1, a support element would adjoin the right side of the brush seal 10 shown there and a cover element of a housing, the left side.

In the embodiment of FIG. 1, the bristles 17, 18 of the interior layer 15 and of the exterior layer 16 are designed in such a way that the free ends 19 or, respectively, 20 of the same define the same interior diameter. Thus, the free ends 19 of the bristles 17 of the interior layer 15 as well as the free ends 20 of the bristles 18 of the exterior layer 16 would lie flat against a rotor.

In contrast, FIG. 2 shows an example of an embodiment of a brush seal 10 according the invention in which the free ends 19 of the bristles 17 of the interior layer 15 define a larger interior diameter than the free ends 20 of the bristles 18 of the exterior layer 16. Thus, in FIG. 2, the bristles 18 of the exterior layer 16 protrude at the interior diameter relative to the bristles 17 of the interior layer 15.

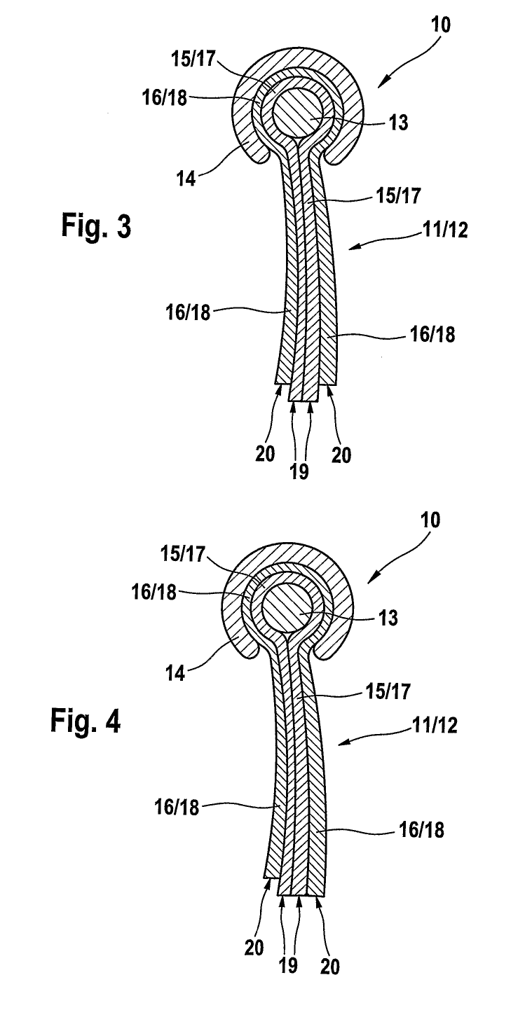

In contrast therewith it will also be possible, as shown in the example of an embodiment of FIG. 3, that the free ends 20 of the bristles 18 of the exterior layer 16 define a greater interior diameter than the free ends 19 of the bristles 17 of the interior layer 15, in which case, in the example of the embodiment of FIG. 3, the bristles 15 of the interior layer 17 will protrude at the interior diameter relative to the bristles 18 of the exterior layer 16.

In the examples of embodiments of FIGS. 1, 2 and 3, the free ends 20 of the bristles 18 of the exterior layer 16 are each designed in such a way that they have the same length on the side of the support element and on the side of the cover element, i.e. that they define the same interior diameter on the side of the support element and on the side of the cover element. In contrast therewith, as can be seen in FIG. 4, it will also be possible that the bristles 18 of the exterior layer 16 will define differing interior diameters on the side of the support element and on the side of the cover element, with, in FIG. 4, the interior diameter of the ends 20 being smaller on the side of the support element than the diameter of the same on the side of the cover element. However, it will also be possible that the bristles 18 of the exterior layer 16 define with their free ends a greater interior diameter on the side of the support element than on the side of the cover element.

All examples of embodiments shown in FIGS. 1 through 4 have in common that the bristles 17 of the interior layer 15 of the bristle packet 11 are designed as carbon fibers and the bristles 18 of the exterior layer 16 or, respectively, the cover layer of the bristle packet 11 as Aramid fibers or wire fibers made of Haynes 25 wire. It is therefore in line with the invention to produce a bristle packet at least in a hybrid construction, with the bristles of an interior layer being made of a different material than the bristles of the exterior layer.

The brush seal according to the invention distinguishes itself through high temperature resistance and high mechanical resistance. Moreover, it tends to generate only a minor amount of heat when brushing against a rotor. A good sealing effect can be realized together with a long service life.

1-14. (canceled)

15. A brush seal to seal a gap between two structural components, the brush seal comprising:
a bristle carrier;
a bristle packet including a plurality of bristles firmly attached to the bristle carrier;
the plurality of bristles including several layers of bristles made of different materials, the layers including an interior layer;
the bristles of the interior layer including bristles that are carbon fibers.

16. A brush seal in accordance with claim 15, wherein the several layers of bristles further include an exterior layer of bristles, the bristles of the exterior layer including bristles that are Aramid fibers.

17. A brush seal in accordance with claim 15, wherein the several layers of bristles further include an exterior layer of bristles, the bristles of the exterior layer including bristles that are wire fibers made of Haynes 25 wire.

18. A brush seal in accordance with claim 15, wherein the bristles of the several layers are configured such that the free ends of the several layers define identical interior diameters.

19. A brush seal in accordance with claim 15, wherein the bristles of the several layers are configured such that the free ends of the several layers define different interior diameters.

20. A brush seal in accordance with claim 19, wherein the several layers include the interior layer and an exterior layer, and the free ends of the bristles of the exterior layer define a smaller interior diameter than the free ends of the bristles of the interior layer.

21. A brush seal in accordance with claim 19, wherein the several layers include the interior layer and an exterior layer, and the free ends of the bristles of the exterior layer define a greater interior diameter than free ends of the bristles of the interior layer.

22. A brush seal in accordance with claim 15, wherein the several layers of bristles further include an exterior layer of bristles having portions disposed on each of a first side and a second side of the interior layer, the bristles of the exterior layer being configured such that the free ends of the bristles of the exterior layer define identical interior diameters on the portion of the exterior layer on the first side of the interior layer and the portion of the exterior layer on the second side of the interior layer.

23. A brush seal in accordance with claim 15, wherein the several layers of bristles further include an exterior layer of bristles having portions disposed on each of a first side and a second side of the interior layer, the bristles of the exterior layer being configured such that the free ends of the bristles of the exterior layer define different interior diameters on the portion of the exterior layer on the first side of the interior layer and the portion of the exterior layer on the second side of the interior layer.

24. A brush seal in accordance with claim 15, wherein the bristles of the bristle packet are firmly attached to the bristle carrier by one of a fixation element and a glue.

25. A sealing arrangement to seal a gap between two structural components, the sealing arrangement comprising:
a housing including a support element and a cover element defining a receptacle;
a brush seal including
a bristle carrier;
a bristle packet including a plurality of bristles firmly attached to the bristle carrier;
the plurality of bristles including several layers of bristles made of different materials, the layers including an interior layer and the bristles of the interior layer including bristles that are carbon fibers; and
wherein the brush seal has at least a portion disposed with the receptacle with the free ends of bristles protruding from the housing.

26. A sealing arrangement in accordance with claim 25, wherein the sealing arrangement is part of a turbo engine and the two structural components are a rotor and a stator.

27. A sealing arrangement in accordance with claim 25, wherein the sealing arrangement is part of a gas turbine and the two structural components are a rotor and a stator.

28. A sealing arrangement in accordance with claim 25, wherein the sealing arrangement is part of a steam turbine and the two structural components are a rotor and a stator.

29. A brush seal to seal a gap between two structural components, the brush seal comprising:
a bristle carrier;
a bristle packet including a plurality of bristles, each bristle having two free ends and a middle portion disposed therebetween, the middle portion of each bristle being firmly attached to the bristle carrier with the free ends extending away from the bristle carrier by a distance defining an interior diameter;
the plurality of bristles including several layers of bristles made of different materials, the layers including an interior layer and an exterior layer, the exterior layer having portion disposed on each of a first side and a second side of the interior layer; and
the bristles of the interior layer including bristles that are carbon fibers.

30. A brush seal in accordance with claim 29, wherein the bristles of the interior and exterior layers are configured such that the free ends define identical interior diameters.

31. A brush seal in accordance with claim 29, wherein the bristles of the interior and exterior layers are configured such that the free ends of the interior layer define a different interior diameter than the free ends of the exterior layer.

32. A brush seal in accordance with claim 31, wherein the free ends of the bristles of the exterior layer define a smaller interior diameter than the free ends of the bristles of the interior layer.

33. A brush seal in accordance with claim 31, wherein the free ends of the bristles of the exterior layer define a greater interior diameter than free ends of the bristles of the interior layer.

34. A brush seal in accordance with claim 29, wherein the bristles of the exterior layer are configured such that the free ends of the bristles of the exterior layer define different interior diameters on the portion of the exterior layer on the first side of the interior layer and the portion on the second side of the interior layer.
